(19) United States
(12) Patent Application Publication
(10) Pub. No.: US 2011/0013766 A1
(43) Pub. Date: Jan. 20, 2011

(54) METHOD AND APPARATUS HAVING ECHO CANCELLATION AND TONE DETECTION FOR A VOICE/TONE COMPOSITE SIGNAL

(76) Inventors: Roman A. Dyba, Cedar Park, TX (US); Hongyang Deng, Austin, TX (US); Wen Wu Su, Austin, TX (US)

Correspondence Address: DILLON & YUDELL LLP, 8911 NORTH CAPITAL OF TEXAS HIGHWAY, SUITE 2110, AUSTIN, TX, 78759, US

(21) Appl. No.: 12/503,345

(22) Filed: Jul. 15, 2009

(51) Int. Cl. H04M 9/08

(52) U.S. Cl. 379/406.08

(57) ABSTRACT

A system includes receive and send inputs, an adaptive filter, a combiner, a non-linear processor, and a tone detector. The receive input receives a first signal having first voice and first tone information. The send input receives a second signal having echo information, second tone information, and second voice information. The adaptive filter has an input coupled to the receive input, and an output. The combiner has a first input coupled to the send input, a second input coupled to the output of the adaptive filter, and an output providing an intermediate signal. The nonlinear processor has an input coupled to the output of the combiner and an output for providing an output signal for obtaining the second voice. The tone detector is coupled to the output of the combiner and detects the second tone in the intermediate signal prior to the intermediate signal being processed by the nonlinear processor.

### BACKGROUND

1. Field

This disclosure relates generally to signal processing, and more specifically, to a method and apparatus having echo cancellation and tone detection for a voice/tone composite signal.

2. Related Art

Echo cancellation is used in a telecommunication network (such as in a Public Switching Telephone Network (PSTN) or Packet Telephony (PT) network) to ensure voice quality through elimination or reduction of electric or line echo from the telecommunication network. The source of this electric or line echo may be the impedance mismatch of a hybrid circuit which is a device used to convert signals from a four-wire communication network interface to a two-wire local subscriber loop and vice versa. Echoes with long delays in the communication network may be noticeable which may create significant or even unbearable disturbance during telephone voice communication. Also, tones may be received via the telecommunication network which need to be detected. However, the nonlinear processing performed in echo cancellers tends to distort in-band signaling, making it increasingly difficult to detect tones.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a communication system in accordance with one embodiment of the present invention.

FIG. 2 illustrates an echo canceller of the communication system of FIG. 1 in accordance with one embodiment of the present invention.

### DETAILED DESCRIPTION

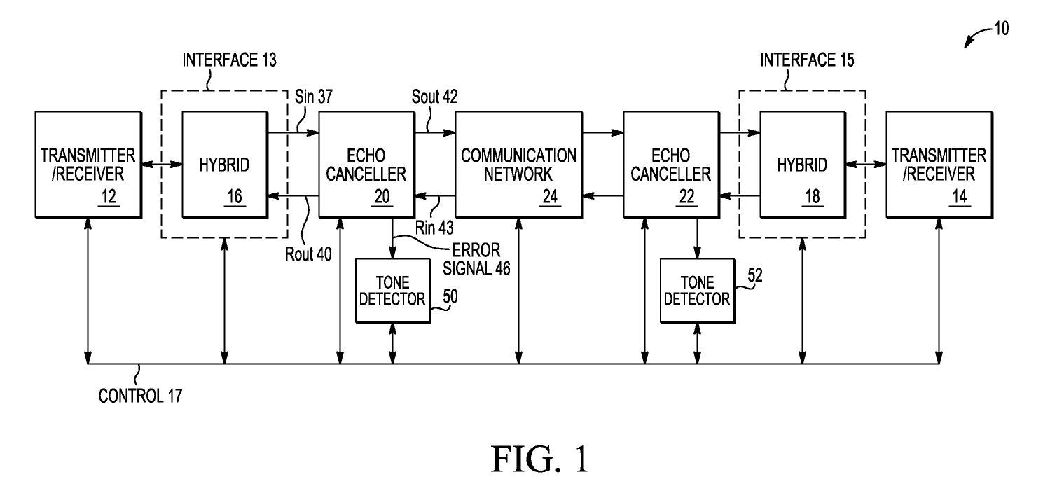

FIG. 1 illustrates one embodiment of a communication system 10. Communication system 10 includes transmitter/receiver 12, interface 13, hybrid circuit 16 (also referred to as hybrid 16), echo canceller 20, tone detector 50, communication network 24, echo canceller 22, tone detector 52, interface 15, hybrid 18, and transmitter/receiver 14. Interface 13 includes hybrid 16 and interface 15 includes hybrid 18. Transmitter/receiver 12 is bidirectionally coupled to hybrid 16 (where, in one embodiment, transmitter/receiver 12 is coupled to hybrid 16 via a two-wire connection such as a twisted pair of wires). Hybrid 16 is coupled to echo canceller 20, providing a send signal Sin 37 to echo canceller 20 via a unidirectional link and receiving a receive signal Rout 40 from echo canceller 20 via a unidirectional link (where, in one embodiment, each of Sin 37 and Rout 40 are provided and received via a wire pair). Echo canceller 20 is coupled to communication network 24 and provides an echo canceller send signal Sout 42 to communication network 24 and receives Rin 43 from communication network 24. Echo canceller 20 provides an error signal 46 to tone detector 50 via a unidirectional link.

Similarly, transmitter/receiver 14 is bidirectionally coupled to hybrid 18 (where, in one embodiment, transmitter/receiver 14 is coupled to hybrid 18 via a two-wire connection such as a twisted pair). Hybrid 18 is coupled to echo canceller 22 via a unidirectional link for providing signals to echo canceller 22 and a unidirectional link for receiving signals from echo canceller 22 (where, in one embodiment, each set of unidirectional link may be a wire pair). Echo canceller 22 is coupled to communication network 24 and provides an echo cancelled send signal to communication network 24 and receives a received signal from communication network 24. Echo canceller 22 also provides an error signal to tone detector 52. Control 17 may be a control bus that includes one or more control signals that may be provided to each of transmitter/receiver 12, hybrid 16, echo canceller 20, tone detector 50, communication network 24, echo canceller 22, tone detector 52, hybrid 18, and transmitter/receiver 14, as needed. Therefore, in one embodiment, control 17 is coupled to every unit within communication system 10, while in alternate embodiments, only a portion of the units may require communication with control 17.

In operation, transmitter/receiver 12, provides and receives communication signals to and from hybrid 16. Hybrid 16 provides for a four-wire to two-wire conversion between transmitter/receiver 12 and communication network 24. Therefore, transmitter/receiver 12 can be any device used for communicating over communication network 24, such as, for example, a telephone or a modem, that is coupled to hybrid 16 via a two-wire subscriber line (i.e. twisted pair of wires). Therefore, hybrid 16 provides an interface between a local subscriber loop (having transmitter/receiver 12) and a communication network (communication network 24). Transmitter/receiver 14 and hybrid 18 functional analogously to transmitter/receiver 12 and hybrid 16, respectively.

In communications between transmitter/receiver 12 and transmitter/receiver 14, electrical or line echo is introduced into the communication by hybrid 16 and hybrid 18. The source of this echo is the impedance mismatch within hybrid 16, as well as the impedance mismatch within hybrid 18. For example, if the impedance within hybrid 16 were perfectly matched, all of the energy from received signal Rout 40 would be transmitted to transceiver/receiver 12. However, if there is any impedance mismatch within hybrid 16, some of the energy from received signal Rout 40 would be reflected back through send signal Sin 37 (note that there is a second source of echo—the transmitters/receivers 12 and 14—that is a result of acoustical coupling between an earpiece and mouthpiece, as in the case of a telephone set). If the round trip delay through communication network 24 (from/to transmitter/receiver 14, in the case of echo introduced by hybrid 16) is sufficiently long, the reflected echo received by transmitter/receiver 14 from Sin 37 will be noticeable during the communication. This may result in noticeable echoes or even unbearable disturbance during a telephone voice communication. In one example, a sufficiently long delay may refer to a round trip delay of greater than 40 milliseconds. As the round trip delay increases, the echoes may become worse and thus more noticeable and disruptive. (If, on the other hand, the round trip delay is significantly smaller, the echo may not be disruptive since it may be indistinguishable from the side tone of the transmitters/receivers 12 and 14, as, for example, in the case of a telephone set.) The round trip delay may include a variety or combination of different delays, including transmission delay, processing delay, computation delay, etc. Depending on the communication system, the round trip delay may be sufficiently large to disrupt communication. Therefore, echo cancellers 20 and 22 may be used to reduce the line echo in communication system 10. For example, the echo introduced by hybrid 16 from a signal received via Rout 40 (from transmitter/receiver 14) and reflected back via Sin 37 is processed via echo canceller 20 to reduce the reflected echo prior to sending the signal Sout 42 through communication network 24 back to transmitter/receiver 14.

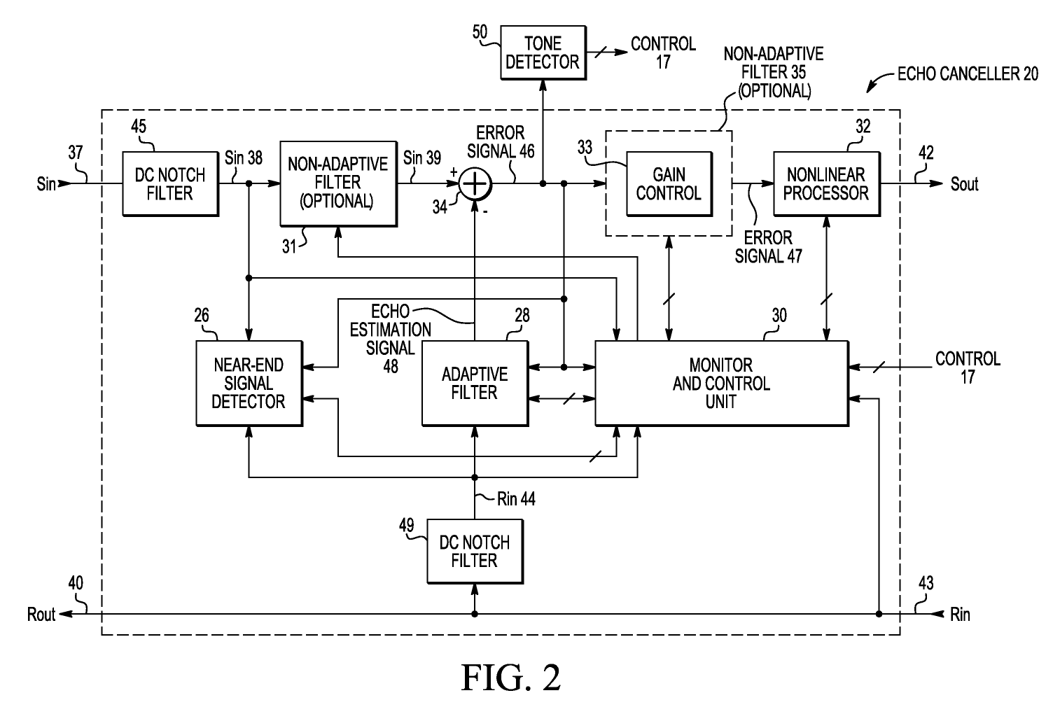

Tone detector 50 receives error signal 46 from echo canceller 20 and performs tone detection to determine if a tone is present within Sin 37. Therefore, the tone detection performed by tone detector 50 is performed on error signal 46 (as will be described in reference to FIG. 2), which is an intermediate signal within echo canceller 20, and is not performed on Sout 42, which is the echo cancelled output of echo canceller 20. For example, in one embodiment, Sin 37 may be a composite signal which includes both voice and tone components (also referred to as voice information and tone information, respectively). Note that the tone components may correspond to single frequency tones and/or multiple frequency tones (and they are also known as in-band signaling tones). However, when the tone components, which are in-band with the voice components, are weak, the processing performed by the nonlinear processor of echo canceller 20 may distort Sout 42 to the point that the tone components cannot easily be detected. Therefore, as will be described below in reference to FIG. 2, error signal 46 is an intermediate signal which has not been processed by the nonlinear processor of echo canceller 20, unlike Sout 42 at an output of echo canceller 20 which has been processed by the nonlinear processor of echo canceller 20. Note that any known tone detector may be used to implement tone detector 50.

In one embodiment, communication network 24 may include a packet telephony network (including, for example, voice over internet protocol (IP), data over packet, asynchronous transfer mode (ATM), etc., and could either apply to wireless or wireline systems) or Public Switching Telephone Network (PSTN). In alternate embodiments, communication system 10 may refer to any type of communication system. Any communication pathway may be used as interface 13 or interface 15.

Control 17 provides a control pathway among transmitter/receiver 12 and 14, hybrid 16 and 18, echo canceller 20 and 22, and communication network 24. Control signals transmitted via control 17 are generally not in-band signals. For example, control 17 may include an enabling/disabling signal to enable or disable echo canceller 20 or 22. Control 17 may also include a signal to indicate whether the telephone is on or off the hook. Tone detector 50 may also send messaging signals via control 17 to indicate, for example, that one or more tones have been detected and their corresponding frequencies.

In the embodiments described herein, transmitter/receiver 12 will be referred to as the near end with respect to echo canceller 20 and transmitter/receiver 14 will be referred to as the far end with respect to echo canceller 20. Therefore, the embodiments herein will be discussed with reference to echo canceller 20; however, it should be understood that echo canceller 22 operates analogously to echo canceller 20. That is, in an alternate embodiment, transmitter/receiver 14 may be referred to as the near end with respect to echo canceller 22 and transmitter/receiver 12 the far end with respect to echo canceller 22. Also, note that tone detector 52 may also operate analogously to tone detector 50.

FIG. 2 illustrates one embodiment of echo canceller 20 of FIG. 1 and includes tone detector 50 of FIG. 1. (Note that in the embodiments discussed in reference to FIG. 2, echo canceller 20 is referred to as the echo canceller at the near end while echo canceller 22 is referred to as the echo canceller at the far end of communication system 10.) Echo canceller 20 includes DC notch filter 45, optional non-adaptive filter 31, adder 34, optional non-adaptive filter 35, gain control 33, nonlinear processor 32, near-end signal detector 26, adaptive filter 28, monitor and control unit 30, and DC notch filter 49. DC notch filter 45 receives Sin 37 and outputs Sin 38 to near-end signal detector 26 and monitor and control unit 30. If non-adaptive filter 31 is present, then Sin 38 is also provided to non-adaptive filter 31 which is coupled to receive controls from monitor and control unit 30 and outputs Sin 39 to adder 34 (which may also be referred to as a combiner). However, if non-adaptive filter 31 is not present, then Sin 38 is the same as Sin 39 which is input to adder 34. Adder 34 receives Sin 39 and echo estimation signal 48 from adaptive filter 28 and provides an error signal 46 to gain control 33, tone detector 50, near-end signal detector 26, and monitor and control unit 30. Gain control 33 is bidirectionally coupled to monitor and control unit 30 and is coupled to provide error signal 47 to nonlinear processor 32. If non-adaptive filter 35 is present in echo canceller 20, then, in one embodiment, gain control 33 is within non-adaptive filter 35 which also receives error signal 46, is bidirectionally coupled to monitor and control unit 30 and provides error signal 47. Nonlinear processor 32 is bidirectionally coupled to monitor and control unit 30 and provides Sout 42. Monitor and control unit 30 is also coupled to control 17, receives Rin 43, receives Rin 44 from DC notch filter 49, and is bidirectionally coupled to adaptive filter 28 and near-end signal detector 26. DC notch filter 49 receives Rin 43 (which, in the illustrated embodiment, is the same as Rout 40) and provides Rin 44 to near-end signal detector 26, adaptive filter 28, and monitor and control unit 30.

FIG. 2 illustrates one embodiment of echo canceller 20, where, as mentioned above, transmitter/receiver 12 is the near end and transmitter/receiver 14 is the far end. Sin 37 is the send signal transmitted from transmitter 12, via hybrid 16. (Note that Sin 37 may include voice information, tone information, and reflected echo from Rin 43.) Echo canceller 20 provides an echo cancelled send signal Sout 42 at its output to receiver 14 via communication network 24 and hybrid 18. Note that in the illustrated embodiment, error signal 46 is not sent to communication network 24. Rin 43 is a receive signal received from transmitter 14 via hybrid 18 and communication network 24. (Note that Rin 43 may include both voice information and tone information.) Echo canceller receives Rin 43 and provides this send signal Rin 43 as Rout 40 to receiver 12 via hybrid 16. In one embodiment, echo canceller 20 is not compliant with the ITU-T Recommendation G.168 for digital network echo cancellers in the sense that it (i.e., the echo canceller) is equipped with 5 communication signal ports. Note that an echo canceller that is compliant with the ITU-T Recommendation G.168 includes 4 communication signal inputs/outputs: a send input, a send output, a receive output, and a receive input. Therefore, in one embodiment, Sin 37 is compliant to the send input of the ITU-T Recommendation G.168, Sout 42 is compliant to the send output of the ITU-T Recommendation G.168, Rout 40 is compliant to the receive output of the ITU-T Recommendation G.168, and Rin 43 is compliant to the receive input of the ITU-T Recommendation G.168. However, the presence of the 5^{th} port (corresponding to the user accessible error signal 46 of echo canceller) causes the status of non-compliance with the current ITU-T Recommendation G.168. Therefore, note that, in the illustrated embodiment, at least a portion of echo canceller 20 (e.g. a portion which excludes a port for error signal 46) is compliant with ITU-T Recommendation G.168.

As discussed above, Sin 37 may include reflected echo introduced by the impedance mismatch within hybrid 16. Therefore, echo canceller 20 reduces (or eliminates) the introduced reflected echo and provides the echo cancelled send signal Sout 42. That is, if the impedance in hybrid 16 is perfectly matched, a signal received at the input of the hybrid 16 (e.g. Rout 40) would result in virtually no response from hybrid 16 (at Sin 37) because there would be no reflected echo (in the ideal and practically unattainable case). However, if the hybrid is in imbalanced state (a typical case, e.g. where the impedance is mismatched), a signal received via Rout 40 results in a hybrid impulse response (h). Adaptive filter 28 within echo canceller 20 attempts to “imitate” the hybrid circuit by producing a replica of the echo signal of any input signal Rout 40; the replica is then subtracted from Sin 39, via adder 34, and the error signal 46 is produced. Note that the echo signal (which is equal to Sin 37 when the transmitter/receiver 12 does not produce any signal, i.e., when the near end signal, Sgen, is zero, or absent) is equal to a linearly distorted signal Rout 40 (these linear distortions include pure transposition in time, i.e., a shift in time by a parameter called pure delay, and they also include other linear distortions that are related to hybrid dispersion properties). Note that the hybrid impulse response includes both a pure delay portion and a dispersion time. The pure delay refers to the portion of the impulse response from the beginning to where some significant values start to occur. The dispersion time refers to the portion of the impulse response duration from where the significant responses start to happen to where the responses virtually disappear. The shape of the impulse response (as per the portion corresponding to the dispersion time segment) can be translated into the frequency characteristic of the hybrid (as seen from Rout 40/Sin 37 input/output ports).

Still referring to FIG. 2, Sin 37 is provided to DC notch filter 45 to remove the DC component from Sin 37. Note that in an alternate embodiment, a high pass filter may be used in place of DC notch filter 45. Similarly, Rout 40 is provided to DC notch filter 49 to remove the DC component from Rout 40 (however, in alternate embodiments, a high pass filter may be used instead). The use of DC notch filters may be computationally cheaper than high pass filters and also result in no rippling effect which helps maintain the gain flat through pass band of the filter. In an alternate embodiment, a single shared DC notch filter may be used to perform the functions of DC notch filter 45 and DC notch filter 49.

Note that non-adaptive filter 31 and non-adaptive filter 35 are optional. For discussions immediately following, it will be assumed that Sin 38 and Sin 39 are equal and error signal 47 is a gain adjusted version of error signal 46, without the effects of non-adaptive filter 35.

Sin 39, therefore, is the send signal which includes any near end signal (Sgen) that is transmitted by transmitter 12 and any reflected echo introduced from Rout 40 (or Rin 43) by hybrid 16. Therefore, Sin 39 can be expressed as “Sgen+echo”. Note that the near end signal (Sgen) may include a voice component (such as when a near end talker is present) and/or one or more tone components. (Note that the voice component may be referred to as voice information and the one or more tone components may be referred to as tone information.) If both a voice component and one or more tone components are present, then Sin 39 may be considered a voice/tone composite signal. Adaptive filter 28 provides an estimation of the reflected echo, echo estimation signal 48, to adder 34, which outputs error signal 46. Therefore, error signal 46 can be expressed as “Sin 39−estimated echo 48” or, substituting the above expression for Sin 39, as “Sgen+echo−estimated echo”. When the estimated echo is accurate (i.e. equal or substantially equal to the actual echo), then error signal 46 will include only Sgen without any substantial echo. This is the ideal case. However, if the estimated echo is not accurate, error signal 46 will include both Sgen and a residual echo component. In this case, error signal 46 can be expressed as “Sgen+residual echo” where residual echo is “echo−estimated echo”. When Sgen is absent (that is, when the near end is silent, meaning no signal is being transmitted from transmitter 12), error signal 46 represents only the residual echo. In this case, error signal 46 may be used to perform an adaptive process to minimize the residual echo, as will be discussed in more detail below. However, if Sgen is present, error signal 46 cannot be used to perform the adaptive process because adaptive filter 28 uses the error to adapt, and with the presence of Sgen, error signal 46 is no longer just the error. Therefore, the detection of Sgen is used to determine whether the adaptive process may be performed. Near-end signal detector 26, coupled to receive Sin 38 (which in this example is equal to Sin 39) and Rin 44, uses error signal 46 and control signals from monitor and control unit 30 to detect the presence of Sgen (i.e. to detect the presence of a near end talker signal at transmitter 12.) Note that any known near-end signal detector may be used to implement near-end signal detector 26.

In adaptive filter unit 28, the echo estimation signal 48, y(k), is calculated by y(k)=X^{T}(k)·H(k), where X(k)=[x(k), x(k−1), . . . , x(k−N+1)]^{T} is the input signal vector extending over the duration of the FIR filter span; x(n)=Rin 44. H(k) is a filter coefficient vector for the k-th iteration where H(k)=[h₀(k), h₁(k), . . . , h_{N-1}(k)]^{T}. The actual update of the filter coefficients is governed by a general LMS-type algorithm: H(k+1)=H(k)+step_size·error(k)·X(k), where error(k) corresponds to error signal 46; step_size controls the adaptation rate; and H(k+1) is a newly updated filter coefficient vector. Note that any other known adaptive algorithm may be used to update the filter coefficients.

Any residual echo in error signal 46 may further be reduced or removed by nonlinear processor 32. Nonlinear processor 32 receives error signal 47 (which in this embodiment is a gain adjusted version of error signal 46) and control signals from monitor and control unit 30 to produce Sout 42, which, ideally, includes no echo and is provided as an output of echo canceller 20 to communication network 24. Any known nonlinear processor may be used to implement nonlinear processor 32, where additional functions may be performed in addition to the removal or reduction of residual error. Note that the nonlinear processing performed by nonlinear processor 32 introduces distortion into Sout 42. Therefore, if Sout 42 is a voice/tone composite signal including both voice and tone components, the distortion by nonlinear processor 32 may make the tone components too difficult to detect by a tone detector. Therefore, in one embodiment, tone detector 50 receives error signal 46, which may be a voice/tone composite signal, and performs tone detection using error signal 46 and does not perform tone detection using Sout 42 (which is an output signal of echo canceller that is provided to communication network 24 and thus back to the far end receiver 14 via hybrid 18). Tone detector 50, by using a signal (such as error signal 46) that is prior to any nonlinear processing (i.e. that has not yet been processed by any of non-adaptive filter 35, if present, gain control 33, or nonlinear processor 32), tone detector 50 may be able to better detect any tone components present in Sin 39 (i.e. Sin 37). That is, error signal 46 may be considered a signal which is void of nonlinear processing. Therefore, in the illustrated embodiment, the output of adder 34 is provided directly to tone detector 50 as well as to nonlinear processor 32 (via gain control 33, if present). In this manner, tone detector 50 operates on a less distorted signal as compared to Sout 42. Therefore, in the illustrated embodiment, note that echo canceller 20 includes 5 communication signal input/outputs: Sin 37, Rout 40, Sout 42, Rin 43, and error signal 46. (As described above, each of Sin 37, Rout 40, Sout 42, and Rin 43 may be compliant with the ITU-T Recommendation G.168. ) However, error signal 46, unlike Sout 42, is not provided to communication network 24. In one embodiment, even though error signal 46 is not provided to communication network 24, it is still user accessible. In this manner, by being user accessible, tone detection can be performed on error signal 46 by an external tone detector.

Monitor and control unit 30 includes a filter coefficient monitor which is used to determine whether a true hybrid exists such that adaptive filter 28 does not attempt to adapt to invalid hybrids. Monitor and control unit 30 may also include a gain monitor to control gain control 33 within optional adaptive filter 35. One purpose of gain control 33 is to maintain the stability of communication system 10. In one embodiment, monitor and control unit 30 also includes a tone indicator and a tone detector for use in controlling adaptive filter 35. In one embodiment, outputs of this tone indicator and tone detector within monitor and control unit 30 are not provided external to echo canceller 20 since they are used for the purpose of controlling adaptive filter 35 and/or other elements within echo canceller 20. The tone indicator and tone detector may be used to detect signaling tones within communication system 10. These signaling tones may include, for example, a 2100 Hz tone with a phase reversal for disabling the echo canceller when data is to be sent following the signaling tone. Therefore, echo canceller 20 may be disabled as necessary. On the other hand, if adaptive filter 28 is exposed to a tone (such as, for example, a single or multiple frequency sinusoidal) transmitted by either transmitter 12 or transmitter 14, instability of communication system 10 may result. Therefore, in one embodiment, detection of a tone may be used to prevent adaptive filter from diverging and causing instability. Monitor and control unit 30 may also receive control 17 to enable or disable all or a portion of the functional modules.

In the embodiments described above, echo canceller 20 did not include non-adaptive filters 31 and 35. However, in an alternate embodiment, non-adaptive filter 31, coupled between DC notch filter 45 and adder 34, can be used to reduce the length of adaptive filter 28. In this embodiment, non-adaptive filter 31 receives Sin 38 and control signals from monitor and control unit 30 to produce Sin 39. Also, in one embodiment having non-adaptive filter 31, echo canceller may also include a non-adaptive filter 35 coupled between adder 34 and nonlinear processor 32. Non-adaptive filter 35 may include gain control 33 or may be a separate unit. In this embodiment, non-adaptive filter 35 compensates the effects of non-adaptive filter 31, so that the near-end signal Sgen is not distorted. Non-adaptive filter 35 receives error signal 46, control signals from monitor and control unit 30, and provides error signal 47 to nonlinear processor 32.

Note that FIGS. 1 and 2 illustrate one embodiment of blocks found within communication system 10 and echo canceller 20. Alternate embodiments may include various different elements than those illustrated, more elements than those illustrated, or less elements than those illustrated, depending on the functionality desired. Furthermore, the blocks within FIGS. 1 and 2 can be grouped differently or connected differently and still achieve similar results. Therefore, FIGS. 1 and 2 are only meant to provide examples used to illustrate the concepts that will be discussed below. Also, although the connections in FIGS. 1 and 2 may have been drawn as a single conductor (unidirectional or bidirectional) or as multiple conductors (unidirectional or bidirectional), a variety of different connections may be used. For example, a multiple conductor can be replaced with a variety of different single unidirectional or bidirectional conductors. Similarly, single conductors can be expanded into multiple unidirectional or bidirectional conductors. Signals can be communicated serially via a single conductor or can be communicated in parallel via multiple conductors. Also, signals can be time multiplexed via single or multiple conductors. Therefore, the connections illustrated in FIGS. 1 and 2 can be implemented in a variety of different ways while still achieving the desired functionality. Also, note that, in one embodiment, the echo canceller and tone detector, such as echo canceller 20 and tone detector 50, are implemented on one or more integrated circuits. In one embodiment, the one or more integrated circuits include one or more processors which execute instructions which cause the one or more integrated circuits to perform the functions of echo canceller 20 and/or tone detector 50. In one embodiment, echo canceller and tone detector are separate components located within a same integrated circuit or located on separate integrated circuits.

By now it should be appreciated that there has been provided an echo canceller which allows for integrated tone detector capabilities. For example, an echo canceller uses both an adaptive filter and nonlinear processing to eliminate echo or reduce them to an acceptable level within a telecommunication network. In the case of composite signals having both voice and tone components, though, the nonlinear processor tends to introduce distortions, such as temporal clipping and/or attenuation. In one embodiment, an echo canceller allows for integrated tone detector capabilities by using an intermediate signal (e.g. error signal 46) within the echo canceller for tone detection rather than an output signal (e.g. Sout 42) of the echo canceller. In one embodiment, the error signal is user accessible (as are the other four signals, Rin 43, Rout 40, Sin 37 and Sout 42) whereby tone detection or other processing may be performed. In one embodiment, the functionality of the tone detection may be subsequently added as a separate module from the echo canceller.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different data processing systems. For example, although FIG. 2 and the discussion thereof describe an exemplary data processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of FIG. 2 are circuitry located on a single integrated circuit or within a same device. Alternatively, the illustrated elements are located on any number of separate integrated circuits or separate devices interconnected with each other. Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements from computer readable media. Such computer readable media may be permanently, removably or remotely coupled to a data processing system which implements echo canceller 20 and/or tone detector 50. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

Although the invention is described herein with reference to specific embodiments, various modifications and changes can be made without departing from the scope of the present invention as set forth in the claims below. For example, the tone detector can be implemented together with the echo canceller or as a separate module. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

The following are various embodiments of the present invention.

Item 1 includes a system having a receive input for receiving a first signal having first voice information and first tone information; a send input for receiving a second signal having echo information from the first signal, second tone information, and second voice information; an adaptive filter having an input coupled to the receive input, and an output; a combiner having a first input coupled to the send input, a second input coupled to the output of the adaptive filter, and an output providing an intermediate signal; a nonlinear processor having an input coupled to the output of the combiner and an output for providing an output signal useful for obtaining the second voice information; and a tone detector coupled to the output of the combiner that detects the second tone in the intermediate signal prior to the intermediate signal being processed by the non-linear processor. Item 2 includes the system of item 1, wherein the send input is coupled to the first input of the combiner through a first DC notch filter. Item 3 includes the system of item 2, wherein the receive input is coupled to the input of the adaptive filter through a second DC notch filter. Item 4 includes the system of item 1, wherein the combiner subtracts a signal present at the second input of the combiner from a signal present in the first input of the combiner. Item 5 includes the system of item 1, and further includes a gain control for coupling the output of the combiner to the input of the nonlinear processor. Item 6 includes the system of item 1, wherein the intermediate signal is further characterized as being an error signal. Item 7 includes the system of item 1, wherein the send input is coupled to the first input of the combiner through a first DC notch filter and a non-adaptive filter, wherein the DC notch filter and the non-adaptive filter are in series. Item 8 includes the system of item 1, wherein a portion of the system complies with a standard called ITU-T Recommendation G.168 for digital network echo cancellers, whereby the output of the nonlinear processor is coupled to a send output, wherein the send output complies with Sout of the standard called ITU-T Recommendation G.168 for digital network echo cancellers. Item 9 includes the system of item 1, wherein the output of the combiner is user accessible.

Item 10 includes a system having an adaptive filter having an input and an output; a combiner having a first input, a second input coupled to the output of the adaptive filter, and an output; a non-linear processor having an input coupled to the output of the combiner and an output; and in compliance with a standard called ITU-T Recommendation G.168 for digital network echo cancellers, a send input Sin coupled to the input of the combiner, a send output Sout coupled to the output of the nonlinear processor, and a receive input coupled to the input of the adaptive filter; wherein the output of the combiner is user accessible whereby tone detection can be performed on the output of the combiner. Item 11 includes the system of item 10, wherein output of the combiner is of a signal that is void of nonlinear processing. Item 12 includes the system of item 11, wherein the combiner subtracts a signal present at the second input of the combiner from a signal present in the first input of the combiner. Item 13 includes the system of item 10, further having a tone detector coupled to the output of the combiner, wherein the tone detector processes the output of the combiner, wherein the output of the combiner is void of nonlinear processing. Item 14 includes the system of item 13, wherein the output of the combiner is characterized as being an error signal, wherein the tone detector performs tone detection on the error signal.

Item 15 includes a method of implementing an echo canceller, the echo canceller comprising an adaptive filter, a combiner, and a nonlinear processor. The method includes coupling a first signal to the combiner, wherein the first signal includes echo information, first voice information, and first tone information; adaptively filtering a second signal to produce a third signal, wherein the second signal includes second voice information and second tone information; providing the third signal to the combiner; subtracting, using the combiner, the third signal from the first signal to provide a fourth signal; performing tone detection, using the tone detector, on the fourth signal to obtain the second tone; and performing processing, using the nonlinear processor, on the fourth signal to produce a fifth signal, wherein the processing comprises nonlinear processing. Item 16 includes the method of item 15, wherein the fourth signal is an error signal. Item 17 includes the method of item 16, and further includes performing DC notch filtering on a send in signal to produce the first signal; and performing DC notch filtering on a receive in signal to produce the second signal. Item 18 includes the method of item 15, wherein the step of performing processing further comprises performing gain control. Item 19 includes the method of item 15, wherein the fourth signal is void of nonlinear processing. Item 20 includes the method of item 15, wherein the first signal, the second signal, and the fifth signal is are user accessible and are provided according to a standard called ITU-T Recommendation G.168 for digital network echo cancellers, and wherein the fourth signal is user accessible.

What is claimed is:

1. A system, comprising:
a receive input for receiving a first signal having first voice information and first tone information;
a send input for receiving a second signal having echo information from the first signal, second tone information, and second voice information;
an adaptive filter having an input coupled to the receive input, and an output;
a combiner having a first input coupled to the send input, a second input coupled to the output of the adaptive filter, and an output providing an intermediate signal;
a nonlinear processor having an input coupled to the output of the combiner and an output for providing an output signal useful for obtaining the second voice information; and
a tone detector coupled to the output of the combiner that detects the second tone in the intermediate signal prior to the intermediate signal being processed by the nonlinear processor.

2. The system of claim 1, wherein the send input is coupled to the first input of the combiner through a first DC notch filter.

3. The system of claim 2, wherein the receive input is coupled to the input of the adaptive filter through a second DC notch filter.

4. The system of claim 1, wherein the combiner subtracts a signal present at the second input of the combiner from a signal present in the first input of the combiner.

5. The system of claim 1, further comprising a gain control for coupling the output of the combiner to the input of the nonlinear processor.

6. The system of claim 1, wherein the intermediate signal is further characterized as being an error signal.

7. The system of claim 1, wherein the send input is coupled to the first input of the combiner through a first DC notch filter and a non-adaptive filter, wherein the DC notch filter and the non-adaptive filter are in series.

8. The system of claim 1, wherein a portion of the system complies with a standard called ITU-T Recommendation G.168 for digital network echo cancellers, whereby the output of the nonlinear processor is coupled to a send output, wherein the send output complies with Sout of the standard called ITU-T Recommendation G.168 for digital network echo cancellers.

9. The system of claim 1, wherein the output of the combiner is user accessible.

10. A system, comprising:
an adaptive filter having an input and an output;
a combiner having a first input, a second input coupled to the output of the adaptive filter, and an output;
a non-linear processor having an input coupled to the output of the combiner and an output; and
in compliance with a standard called ITU-T Recommendation G.168 for digital network echo cancellers, a send input Sin coupled to the input of the combiner, a send output Sout coupled to the output of the nonlinear processor, and a receive input coupled to the input of the adaptive filter;
wherein the output of the combiner is user accessible whereby tone detection can be performed on the output of the combiner.

11. The system of claim 10, wherein output of the combiner is of a signal that is void of nonlinear processing.

12. The system of claim 11, wherein the combiner subtracts a signal present at the second input of the combiner from a signal present in the first input of the combiner.

13. The system of claim 10, further comprising a tone detector coupled to the output of the combiner, wherein the tone detector processes the output of the combiner, wherein the output of the combiner is void of nonlinear processing.

14. The system of claim 13, wherein the output of the combiner is characterized as being an error signal, wherein the tone detector performs tone detection on the error signal.

15. A method of implementing an echo canceller, the echo canceller comprising an adaptive filter, a combiner, and a nonlinear processor; the method comprising:
coupling a first signal to the combiner, wherein the first signal includes echo information, first voice information, and first tone information;
adaptively filtering a second signal to produce a third signal, wherein the second signal includes second voice information and second tone information;
providing the third signal to the combiner;
subtracting, using the combiner, the third signal from the first signal to provide a fourth signal;
performing tone detection, using the tone detector, on the fourth signal to obtain the second tone; and
performing processing, using the nonlinear processor, on the fourth signal to produce a fifth signal, wherein the processing comprises nonlinear processing.

16. The method of claim 15, wherein the fourth signal is an error signal.

17. The method of claim 16, further comprising:
performing DC notch filtering on a send in signal to produce the first signal; and
performing DC notch filtering on a receive in signal to produce the second signal.

18. The method of claim 15, wherein the step of performing processing further comprises performing gain control.

19. The method of claim 15, wherein the fourth signal is void of nonlinear processing.

20. The method of claim 15, wherein the first signal, the second signal, and the fifth signal are user accessible and are provided according to a standard called ITU-T Recommendation G.168 for digital network echo cancellers, and wherein the fourth signal is user accessible.
